(19) United States
(12) Patent Application Publication
(10) Pub. No.: US 2026/0336241 A1
(43) Pub. Date: Oct. 29, 2026

(54) TIRE BUILDING DRUM PROVIDED WITH AN INTEGRATED ATTACHMENT DEVICE COMPRISING A RETRACTABLE CLAMPING BLADE

(71) Applicant: Compagnie Generale Des Etablissements Michelin, Clermont-Ferrand (FR)

(72) Inventors: Gilles MIOCHE, Clermont-Ferrand (FR); OlivIer GONNARD, Clermont-Ferrand (FR)

(21) Appl. No.: 19/111,508

(22) PCT Filed: Sep. 14, 2023
(86) PCT No.: PCT/EP2023/075240

§ 371 Date: Mar. 13, 2025

(30) Foreign Application Priority Data
Sep. 27, 2022 (FR) 2209800

(51) Int. Cl. B29D 30/26; B29D 30/24

(52) U.S. Cl. CPC B29D 30/26; B29D 30/242; B29D 2030/2685

(57) ABSTRACT

The drum has a central axis and has a receipt surface, which is designed to receive at least one component element of the tire. The drum has an attachment device which is designed to maintain the component element of the tire on the receipt surface. The attachment device has a base by means of which the attachment device is secured on the drum, a clamping jaw which is formed by a leaf spring, and an actuation mechanism with an articulated quadrilateral, comprising a first arm and a second arm which is shorter than the first arm. This makes the clamping jaw go alternately from a position of rest to a position of work where the clamping jaw exerts a clamping force on the component element of the tire.

### CROSS-REFERENCE TO RELATED APPLICATION

The subject application claims priority to PCT Application No. PCT/EP2023/075240, filed 14 Sep. 2023, and entitled “TYRE BUILDING DRUM PROVIDED WITH AN INTEGRATED ATTACHMENT DEVICE COMPRISING A RETRACTABLE CLAMPING BLADE,” and to French Patent Application No. FR2209800, filed 27 Sep. 2022, and entitled “TYRE BUILDING DRUM PROVIDED WITH AN INTEGRATED ATTACHMENT DEVICE COMPRISING A RETRACTABLE CLAMPING BLADE,” the entire contents of which are both herein incorporated by reference.

### BACKGROUND

### 1. Field

The present disclosure concerns the field of tire building, in particular pneumatic tires for vehicle wheels.

More particularly, the present disclosure concerns the drums which are used to build an annular tire component, by winding on the drum one or a plurality of elements which are in the form of a strip.

The present disclosure applies in particular when it is wished to build annular reinforcements, known as “wraps”, which are designed to form a strapping band in the crown of a tire for a vehicle wheel, and, for this purpose, there is wound on a drum, in a plurality of contiguous helical turns (which can for example overlap axially, or on the other hand be juxtaposed axially without overlapping), a rubber-based strip which contains continuous reinforcement wires parallel to one another, positioned in the direction of the length of the strip.

### 2. Related Art

One of the difficulties of a winding operation of this type is to maintain the front end portion of the strip firmly on the drum, in the required starting position, in order, when the drum is rotated, to allow it to draw the strip after it without sliding the front end portion of the strip or allowing it to fall under the effect of tension, gravity, or centrifugal force.

When the rubber which constitutes the strip has sufficient tack (i.e., sufficient intrinsic adherence power) it can be envisaged to attach the front end portion of the strip on the drum simply by placing the end portion against the surface of the drum. It will be appreciated that the solidity of an attachment of this type depends on the affinity which exists firstly between the material of the rubber-based strip, and secondly the surface of the drum. This affinity can vary greatly depending on whether the surface of the drum on which it is wished to place the component element of the tire is made of metal and bare, or on the other hand is already coated with a first component element of the tire forming a first rubber-based layer.

Similarly, when the strip contains metal reinforcement wires with magnetic sensitivity, it is possible to use a magnet to make the strip adhere to the drum.

However, not all strips are adhesive or magnetisable.

An attachment device has thus been envisaged, as disclosed in application WO-2020/08069 filed by the applicant, which uses retractable needles deployed from the drum, in order to project from the surface of the drum, obliquely in relation to the surface of the drum, so as to prick the strip, and thus maintain the strip in place.

Although this device can admittedly give good results, it can also sometimes suffer from certain disadvantages.

A first possible disadvantage concerns relative fragility of the needles.

A second possible disadvantage concerns the difficulty of adapting the device to the variety of tires built, since, depending on the tire being built, and in particular depending on the dimensions of the tire, it may be necessary to lay strips with very different widths, and/or have to adopt starting positions for the winding which vary greatly along the axis of the drum, from one tire model to another, or from one component element to another.

### SUMMARY

Consequently, the objectives assigned to the disclosure are aimed at eliminating the aforementioned disadvantages, and proposing a new attachment device which makes it possible to maintain a component element of a tire temporarily and reversibly on a building support such as a drum, which attachment device, while guaranteeing firm and reliable maintenance of the component element of the tire, and remaining light, compact and inexpensive, has good polyvalence which allows it to adapt to a wide variety of tires and associated building configurations.

The objectives assigned to the disclosure are achieved by means of a drum for building of a tire. The drum has a central axis and a radially outer surface, known as the “receipt surface.” The receipt surface extends along and around the central axis and is designed to receive at least one component element of the tire. The drum comprises an attachment device which is designed to maintain the component element of the tire on the receipt surface. The attachment device includes a base which is attached on the drum such that the attachment device is supported by the drum. A clamping jaw, which is designed to adopt a so called “position of work”, in which the clamping jaw is supported on a radially outer face of the component element of the tire. An opposite face, forming a radially inner face, of the component element of the tire, is supported on the receipt surface, in order to exert on the component element of the tire a radial compression force, known as the “clamping force.” The clamping force maintains the component element of the tire on the receipt surface. An actuation mechanism, which is supported by the base, connects the clamping jaw to the base. The actuation mechanism is designed to make the clamping jaw execute, in relation to the base and thus in relation to the receipt surface, alternately a first movement, known as the “engagement movement”, which makes it possible to bring the clamping jaw from a position of rest to the position of work, and a second movement, known as the “disengagement movement”, which makes it possible to return the clamping jaw to the position of rest, by displacing the clamping jaw so as to be withdrawn from the position of work, both according to a radial component, in order to release the clamping force, and according to an axial component, in order to clear the axial area which is occupied, on the receipt surface, by the component element of the tire.

Advantageously, by incorporating the attachment device in the drum, such that the attachment device is permanently integral with the drum. More particularly, the attachment device is integral with the receipt surface of the drum. A structure is obtained which is simple, compact and light and which in particular does not require provision of complex apparatus and is distinct from the drum in order to bring and position the attachment device opposite the receipt surface and/or to rotate the attachment device synchronously with the drum.

Advantageously, the actuation mechanism according to the present disclosure makes it possible to carry out easy clamping of the component element of the tire by gripping by means of a clamping jaw. During the engagement movement, the clamping jaw approaches the receipt surface via an approach trajectory comprising a radial component. The clamping jaw can thus press the component element of the tire efficiently and stably against the receipt surface of the drum by applying a clamping force which is radial and is thus oriented substantially in a direction normal to the receipt surface.

The clamping jaw can thus come into contact with the component element of the tire then intensify the force it exerts on the component element of the tire against the receipt surface which supports the component element of the tire until the required intensity of radial clamping force is obtained. This is achieved without any risk of making the component element of the tire slide on the receipt surface in relation to the position which it is wished to allocate to the component element of the tire and which typically corresponds to the starting position of the winding. The attachment device according to the present disclosure thus makes it possible to provide reliably and reproducibly, clamping and maintenance which are both firm and stable, of one component element of the tire to the other.

In addition, this same actuation mechanism according to the present disclosure makes it possible to define precisely the position and extent of the area which is covered, in particular axially, by the clamping jaw when the clamping jaw is in the position of work. It is thus assured in particular that the area which is covered by the clamping jaw in the position of work is sufficiently extensive to maintain the component element of the tire firmly on the receipt surface while being sufficiently small for the clamping jaw not to interfere during the winding of the component element of the tire on the drum, with the laying trajectory which is followed by the component element of the tire in particular in this case a helical laying trajectory.

In other words, the attachment device, and more particularly the clamping jaw, is advantageously configured not to impede the laying of the component element of the tire and in particular not to become wedged below one or a plurality of thicknesses of the component element of the tire thus laid.

Finally, the actuation mechanism according to the present disclosure advantageously makes it possible, during the disengagement movement, once the component element of the tire has been wound on the drum, firstly to remove the clamping jaw from the receipt surface at least according to a movement component which is centrifugal radial, and consequently substantially normal to the receipt surface. This makes it possible to eliminate the clamping by releasing the radial clamping force and separating the clamping jaw from the component element of the tire while avoiding damaging the component element of the tire or accidentally making it slide on the receipt surface.

Again, this same actuation mechanism also makes it possible to retract the clamping jaw axially, advantageously without the clamping jaw rubbing against the component element of the tire, such as to place the clamping jaw in a position of rest which is on the exterior of the area of the receipt surface occupied axially by the component element of the tire located on the drum.

It is therefore easy to access the area of the receipt surface thus disengaged. Therefore, the component element of the tire is located on the drum either to lay and wind on the component element of the tire a second component element of the tire so as to continue the building cycle in progress for the purpose of producing a stratified tire structure or to remove the annular unit formed by the component element of the tire located on the drum and therefore clear the receipt surface of the drum, in order, without being impeded by the clamping jaw to engage the component element of a subsequent tire and thus begin a new building cycle.

Thus, the attachment device according to the present disclosure does not impede either the laying and initial attachment of the component element of the tire on the drum or the winding on the drum of the component element of the tire or the removal after winding of the component element of the tire.

In addition, as will be described hereinafter, the attachment device according to the invention is easily reconfigurable and in particular makes it possible to adapt the axial size of the clamping jaw and/or to adapt the axial and/or radial course of the clamping jaw by means of a simple change of clamping jaw according to the dimensions of the component element of the tire from the required starting position. If applicable, the level of overlapping which it is wished to obtain between consecutive turns of the component element of the tire. The attachment device thus has a great capacity for adapting to highly varied structures and dimensions of tires.

### BRIEF DESCRIPTION OF THE DRAWINGS

Other objectives, characteristics and advantages of the present disclosure will become apparent in greater detail from reading the following description as well as by means of the appended drawings, provided purely by way of non-limiting illustration, in which:

FIG. 1A illustrates, according to an overall view in perspective, a drum according to the present disclosure which is provided with an attachment device incorporated in one of the tiles which constitute the drum, the clamping jaw of which attachment device is in the position of work and is maintaining the front end portion of a strip pressed against the receipt surface of the drum, which receipt surface in this case corresponds to the radially outer face of the tile.

FIG. 1B is a detailed insert view of FIG. 1, in the area of the drum which supports the attachment device.

FIG. 2 is a detailed view in perspective of the tile of the drum in FIGS. 1A and 1B, the attachment device of which is exerting a substantially radial clamping force on the end portion of the strip by means of its clamping jaw placed in the position of work.

FIG. 3 is a view in detail, with a cut-out, of the tile of FIG. 2, showing the actuation mechanism of the attachment device, in this case an actuation mechanism which comprises an articulated quadrilateral supporting the clamping jaw, with the clamping jaw in the position of work.

FIG. 4 is a view in detail, with a cut-out, of the tile in FIGS. 2 and 3, showing the mechanism for actuation of the attachment device, with the clamping jaw this time being in the position of rest.

FIGS. 5, 6, 7 and 8 illustrate according to views in detail in cross-section on a radial plane containing the central axis of the drum, the attachment device and its actuation mechanism in different successive phases of the movement of disengagement, with FIG. 5 corresponding to the position of work, FIG. 8 to the position of rest, and FIGS. 6 and 7 to a first intermediate position and a second intermediate position.

### DETAILED DESCRIPTION OF THE ENABLING EMBODIMENT

The present disclosure concerns a drum 1 for building of a tire.

The tire can preferably be a tire which is designed to equip a wheel of a vehicle, and more particularly a pneumatic tire. However, in a non-limiting manner, the present disclosure can also be used to build tires of another type, such as for example caterpillar bands, belts, or also conveyor belts.

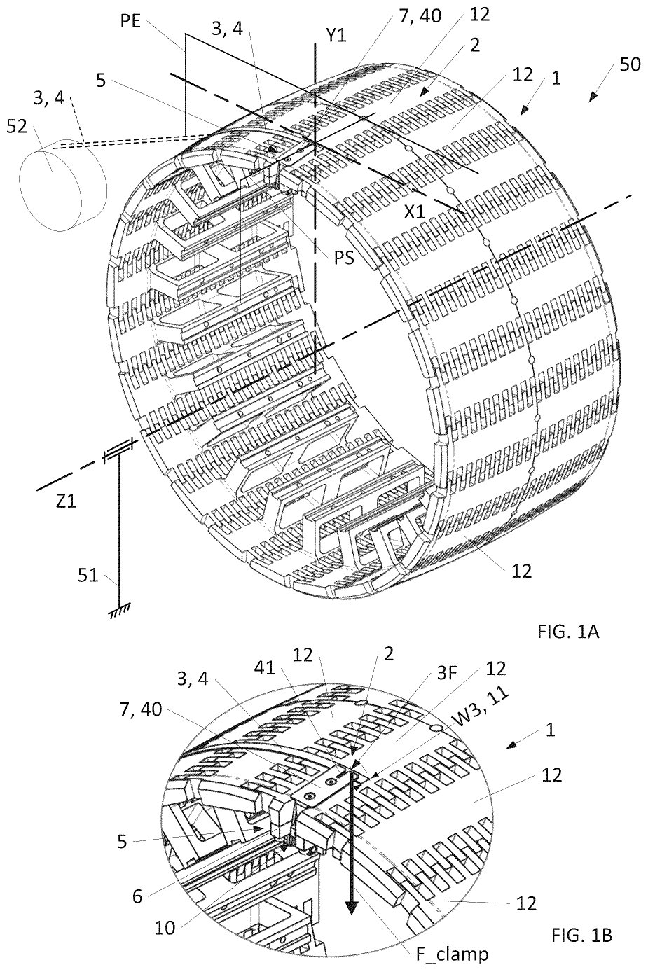

As can be seen clearly in FIG. 1A, the drum 1 has a central axis Z1, and has an outer radial surface 2, known as the “receipt surface” 2, which extends along and around the central axis Z1 and is designed to receive at least one component element 3 of the tire.

The receipt surface 2 has substantially a form of revolution around the central axis Z1. This form is preferably a straight cylindrical form (the generatrices of which are straight lines parallel to the central axis Z1) or, even more preferably, is a slightly curved form in the shape of a barrel (the generatrices of which are curved and concave in relation to the central axis Z1 in order to be curved towards the exterior).

“Axial” designates a direction which is parallel to the axis concerned, in this case more particularly a direction parallel to the central axis Z1 of the drum.

“Radial” designates a direction which is perpendicular to the axis concerned, in this case more particularly a direction Y1 which is perpendicular to the central axis Z1 of the drum, or, if applicable, by equivalence, a direction which is normal to the receipt surface 2 at the point concerned.

“Circumferential” designates a direction which is orthoradial (i.e., a direction which at a point concerned, is normal to the radial plane which contains the axis concerned) and passes via the point concerned. More particularly, a circumferential direction X1 will be taken into consideration here, which is normal, at the point concerned, to the radial plane which contains the central axis Z1 of the drum 1 and passes via the point concerned. The circumferential direction is thus contained on a plane normal to the axis concerned and, on this plane normal to the axis concerned, is perpendicular to the radius which joins the axis concerned to the point concerned.

The component element of the tire 3 is preferably a strip 4 which, when the component element of the tire 3 reaches the receipt surface 2, extends in length substantially in a circumferential direction X1 tangent to the receipt surface 2, in width W3 substantially in the axial direction defined by the central axis Z1 of the drum, and in thickness E3 in the radial direction Y1.

The component element of the tire 3, and more particularly the strip 4, preferably contains reinforcement wires which extend continuously in the direction of the length of the component element of the tire 3 parallel to one another and parallel to the lateral edges of the component element of the tire 3. These reinforcement wires serve the purpose of making the component element of the tire 3 virtually non-extensible in longitudinal traction.

These reinforcement wires can be made of any appropriate material, for example of metal, or of polymer (for example aramide), natural textile fibres, or also glass fibres.

These reinforcement wires can be incorporated in a matrix made of any appropriate material.

In particular, the metal reinforcement wires or the polymer reinforcement wires can preferably be embedded in a rubber-based matrix. As a variant, it is possible to have glass fibre reinforcement wires embedded in a resin matrix, such that the component element of the tire 3 forms a glass-resin compound.

Preferably, the drum 1 is fitted such as to rotate around its axis Z1, such that the rotation of the drum 1, and thus of its receipt surface 2, makes it possible to wind the component element of the tire 3 on the receipt surface 2 in one or a plurality of turns around the central axis Z1, such that an annular unit is formed together with the component element of the tire 3.

The drum 1 comprises an attachment device 5 which is designed to maintain the component element of the tire 3 on the receipt surface 2.

The attachment device 5 is designed to assure temporary and reversible attachment of the component element of the tire 3 on the receipt surface 2 and in particular at the beginning of the winding operation and more preferably throughout the duration of the winding operation. Once the winding operation has been completed, the attachment device 5 is designed to be able to release the component element of the tire 3 and more globally the annular unit which will result from the winding operation.

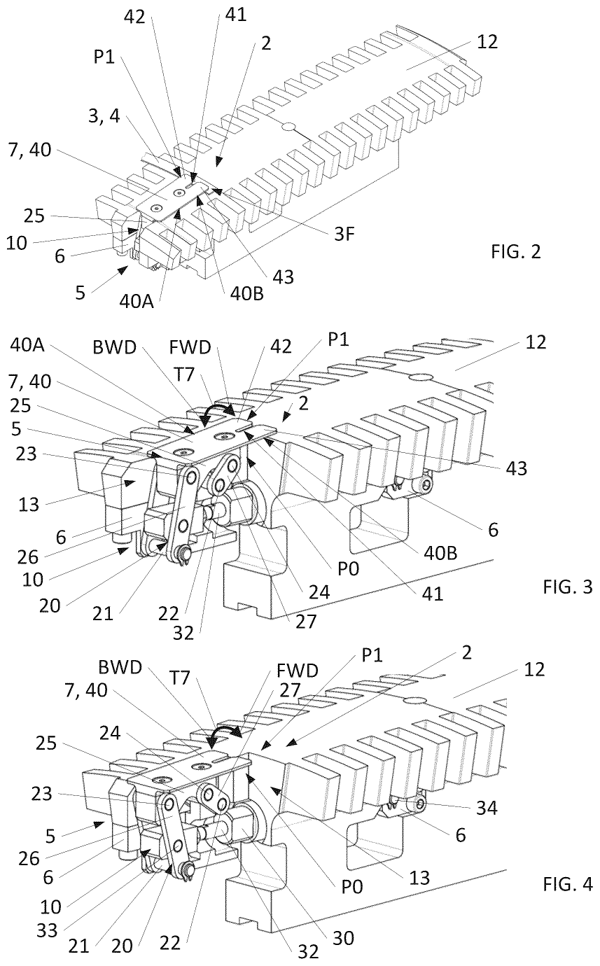

As can be seen in particular in FIGS. 1A, 1B and 2, the attachment device 5 is more particularly designed to maintain a front end portion 3F of the component element of the tire 3 in an area of the receipt surface 2 which corresponds to the starting position from which it is wished to wind the component element of the tire 3 onto the drum 1.

In practice, the aforementioned front end portion 3F advantageously corresponds to the frontal end of the strip 4.

According to the present disclosure, the attachment device 5 comprises a base 6 which is attached on the drum 1 such that the attachment device 5 is supported by the drum 1.

Advantageously, the attachment device 5 is thus on board the drum 1 and is coupled permanently to the receipt surface 2 for as long as the base 6 remains attached on the drum 1. The attachment device 5 is thus spontaneously integral with the movements of the drum 1 and more particularly with the movements of the receipt surface 2, which in this case are the movements of rotation of the receipt surface 2 around the central axis Z1.

Thus, the attachment device 5 does not require additional apparatus distinct from the drum 1 in order to bring the attachment device 5 towards the drum 1, position the attachment device 5 appropriately relative to the drum, then rotate the attachment device 5 synchronously with the drum 1 around the central axis Z1.

The attachment of the base 6 on the drum is advantageously reversible such as to permit dismantling of the attachment device 5 for the purpose of its maintenance or replacement.

This attachment can be carried out for example by means of screws.

In particular, the base 6 allows the attachment device 5 to remain attached on the drum 1, and thus to be coupled to the receipt surface 2, without interruption from one operation of winding of a component element of a tire 3 to another operation of winding of a component element of a tire 3.

Thus, the base 6 allows the attachment device 5 to remain attached on the same drum 1 while the drum 1 is transferred if applicable between a plurality of successive building stations, thus making it possible to lay in succession on the drum 1 and in particular to stack in successive layers on the drum 1 a plurality of component elements 3 of the same tire. The base 6 also allows the attachment device 5 to remain attached on a single drum 1 without interruption during a plurality of consecutive building cycles, during which the same drum 1 is reused at each building cycle, in order to build a plurality of successive distinct tires on the drum 1.

The attachment device 5 also comprises a clamping jaw 7, which is designed to adopt a position P1 known as the “position of work” P1, in which, as shown in FIGS. 1A, 1B, 2 and 5, the clamping jaw 7 is supported on a radially outer face 3_out of the component element 3 of the tire, whereas an opposite face, forming a radially inner face 3_in of the component element 3 of the tire, is supported on the receipt surface 2, in order to exert on the component element 3 of the tire a radial compression force F_clamp, known as the “clamping force” F_clamp, which maintains the component element 3 of the tire on the receipt surface 2.

In the position of work P1, the clamping jaw 7 thus ensures stable maintenance of the component element of the tire 3 by gripping against the receipt surface 2. This makes it possible to start the winding operation, and, more particularly, allows the receipt surface 2 to start to rotate around the central axis Z1, and to draw the component element of the tire 3 after it by means of circumferential traction, without risk of the component element of the tire 3 being displaced on the receipt surface 2 in relation to its required starting position, or being accidentally detached from the receipt surface 2.

Preferably, for better stability, the component element of the tire 3 is compressed by the clamping force F_clamp in the direction of its thickness E3, which thickness E3 in this case corresponds to the distance which separates the radially inner face 3_in from the radially outer face 3_out of the element 3, and also preferably corresponds to the smallest dimension of the component element of the tire 3.

It will be noted that the front end portion 3F of the component element of the tire 3, in this case more particularly the strip 4, can have a straight front (i.e., a front which extends perpendicularly to the two edges of the element 3, in this case of the strip 4) or a bevelled front which extends obliquely from one edge to the other, thus forming an angle, and therefore a point, in relation to one of the edges of the element 3, in this case one of the edges of the strip 4.

The attachment device 5 according to the present disclosure is particularly well-suited to the maintenance of strips 4 with a frontal bevel, since the attachment device 5 can assure a good grip on the strip 4, even if the radially outer face 3_out of the strip 4 has a restricted surface area because of the presence of the bevel.

The attachment device 5 also comprises an actuation mechanism 10, which is supported by the base 6, and connects the clamping jaw 7 to the base 6, the actuation mechanism 10 being designed to make the clamping jaw 7 execute alternately in relation to the base 6, and thus in relation to the receipt surface 2 a first movement FWD, known as the “engagement movement” FWD, which allows the clamping jaw 7 to be brought from a position of rest P0 to the position of work P1 and a second movement BWD, known as the “disengagement movement” BWD, which makes it possible to return the clamping jaw 7 to the position of rest P0, by moving the clamping jaw 7 back from the position of work P1, both according to a radial component BWD_R1, which in this case is a centrifugal radial component, in order to release the clamping force F_clamp, and according to an axial component BWD_A, in order to clear the axial area 11, which is occupied, on the receipt surface 2, by the component element of the tire 3.

The clamping jaw 7 is thus a movable jaw which is placed under the dependence of the actuation mechanism 10.

Advantageously, when the clamping jaw 7 is occupying its position of rest P0, as illustrated in FIGS. 4 and 8, the clamping jaw 7 is retracted to an axial distance sufficient not to impede the laying of a subsequent component element 3.

Thus, for example, if a first winding operation has made it possible to wind on a drum a strip 4 in a plurality of turns in order to form a reinforcement belt, the movement of disengagement BWD makes it possible to clear completely the space situated radially plumb with the strip 4, and more globally radially plumb with the reinforcement belt, thus clearing the access for laying of another component element 3, such as a tread, which is superimposed on the reinforcement belt.

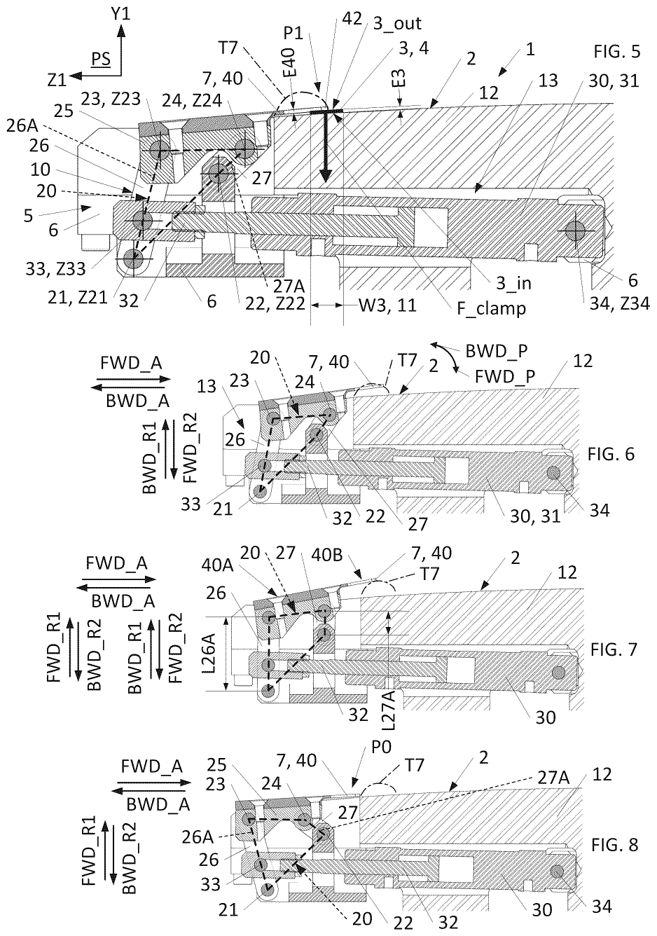

Preferably, the trajectory T7 of the clamping jaw 7 during the movement of disengagement BWD is curved, such as to combine with an axial component BWD_A firstly a first radial component BWD_R1 (FIG. 6) according to which the clamping draw 7 goes away from the central axis Z1 of the drum, in order to be detached from the component element of the tire 3 without rubbing on the radially outer face 3_out of the element 3, then a second radial component BWD_R2 according to which the clamping jaw approaches the central axis Z1 in order to reach the position of rest P0 (FIG. 8).

Thus, during the movement of disengagement BWD, the trajectory T7 of the clamping jaw 7 has, on a radial reference plane containing the central axis Z1 of the drum 1, a concave, quasi-parabolic form, in relation to the central axis Z1 of the drum.

Advantageously, a concave trajectory T7 of this type makes it possible to reach a position of rest P0 in which the clamping jaw 7 projects little or not at all radially relative to the receipt surface 2.

More particularly, when the clamping jaw 7 is in the position of rest P0, the clamping jaw 7 remains contained in the interior of a fictitious envelope which is centered on the central axis Z1, and the radius of which, considered on a plane normal to the central axis Z1, is obtained by applying to the radius of the receipt surface 2, considered on the plane normal to the central axis Z1, a homothetic transformation centered on the central axis Z1, and the homothetic ratio of which is 105% or less, preferably 102% or less, or preferably 101% or less, optionally 100.5% or less. The fictitious envelope thus has the same general form as the real receipt surface 2 (for example a straight cylinder or a form slightly curved in the shape of a barrel), but with a radius, or radii, if the radius varies along the central axis Z1, which is/are slightly larger than the corresponding radius/radii of the receipt surface 2.

In other words, the thickness according to which the clamping jaw 7, in the position of rest P0, optionally projects radially beyond the receipt surface 2, represents less than 5%, preferably less than 2%, or even less than 1%, or optionally less than 0.5%, of the radius of the receipt surface 2 at the x-axis concerned, along the central axis Z1.

By way of indication, the additional radial thickness added by the clamping jaw 7, in the position of rest P0, in relation to the receipt surface 2, is preferably less than 4 mm, 3 mm, or even 1.5 mm.

The radius of the receipt surface 2 for its part can for example be between 300 m and 400 m, and in particular equal to 350 mm+/−20 mm, in particular in the area occupied by the clamping jaw 7 in the position of rest P0.

In this case also, this allows the attachment device 5 to remain compact and discreet, and, when the clamping jaw 7 is in the position of rest P0, it prevents the jaw from impeding access to the receipt surface 2, or creating on the drum 1 an imbalance or a projecting obstacle which would be liable to interfere with an object on the exterior of the drum 1 during the rotation of the receipt surface 2.

In particular, after having placed on the drum 1 a first component element of the tire 3 forming a reinforcement belt, then having retracted the clamping jaw 7 to the position of rest P0, an arrangement of this type makes it possible in particular to lay a tread securely, thus forming a second component element of the tire, above the reinforcement belt.

The movement of engagement FWD which makes it possible to go from the position of rest P0 to the position of work Pl is preferably carried out according to the same spatial trajectory T7 as the movement of disengagement BWD, simply by travelling the trajectory T7 in the inverse direction.

The movement of engagement FWD thus also comprises at least one centripetal radial component FWD_R2, in particular in the final phase of the movement of engagement FWD.

This centripetal radial component FWD_R2 advantageously allows the clamping jaw 7 to approach the outer radial face 3_out of the component element of the tire 3 according to a quasi-radial or exactly radial approach, which guarantees the application of a radial clamping force F_clamp and thus of radial compression of the component element of the tire 3, without any risk of giving rise to undesirable axial or circumferential sliding of the component element of the tire 3 in relation to the receipt surface 2.

It will be noted that, if, in the manner of the movement of disengagement BWD, the movement of engagement FWD follows a quasi-parabolic concave trajectory T7, then the movement of engagement FWD will comprise, in combination with an axial component FWD_A which brings the clamping jaw axially towards the required area on the receipt surface 2, a first centrifugal radial component FWD_R1, in the initial phase of the movement of engagement FWD, then a second centripetal radial component FWD_R2 in the final phase of the movement of engagement FWD.

Preferably, the drum 1 is subdivided into a plurality of tiles 12, which are distributed at the azimuth around the central axis Z1, such as to form together the receipt surface 2.

In a known manner, and as shown in FIGS. 1A, 1B and 2, tiles 12 of this type can have edges forming combs, such as to be able to fit into one another, so that the tiles 12 assure the continuity of the receipt surface on the circumference of the drum 1, while having relative mobility between adjacent tiles.

Advantageously, this relative circumferential mobility, in combination with a radial expansion/retraction mechanism, makes it possible to modify the radial position of the tiles 12, and consequently the diameter of the drum 1, and more particularly the diameter and thus the circumference of the receipt surface 2, and consequently the diameter of winding of the component element of the tire 3, according to the dimensions of the tire to be built.

Preferably, the attachment device 5 is incorporated in one of the tiles 12.

More particularly, the base 6 can be attached, reversibly, for example by being screwed, in a receptacle 13 which is hollowed in the radially inner face of the tile 12, whereas the radially outer face of the tile 12 forms a portion of the receipt surface 2.

In addition, at least part of the actuation mechanism 10 is preferably contained in the receptacle 13, recessed radially from the receipt surface 2.

The attachment device 5 is thus particularly compact, since the attachment device 5 is at least partly contained in the (radial) thickness of the tile 12 itself, and more globally at least partly, or almost entirely, contained in the interior of the envelope which delimits radially the receipt surface 2 around the central axis Z1.

Preferably, the attachment device 5 is situated on the axially outer lateral edge of the tile 12 (i.e., on the free edge of the tile 12) corresponding to the edge of the tile 12 which is furthest axially from the plane known as the “equatorial plane” PE of the drum. The equatorial plane PE of the drum is the plane which is normal to the central axis Z1 and is situated halfway along the width of the drum 1 (i.e., axially equally spaced from each of the axial ends of the drum 1), and more particularly equally spaced from each of the axial ends of the receipt surface 2.

Thus, by being placed at the cant of the tile 12, and more globally at a cant of the drum 1, the attachment device 5 does not encumber the receipt surface 2 and can easily retract the clamping jaw 7 to a position of rest P0 which is situated at a free axial end of the receipt surface 2, axially spaced from the central area of the receipt surface 2.

Advantageously, when it is in the position of rest P0, the clamping jaw 7 remains contained axially in the overall axial area occupied by the drum 1, and more particularly in the overall axial area occupied by the receipt surface 2, such that the clamping jaw 7 does not project axially in relation to the lateral cants of the drum 1, and more particularly in relation to the receipt surface 2, and in particular in relation to the axially outermost edge of the tile 12 which bears the attachment device 5.

Thus, by being inscribed in the axial envelope of the drum 1, and more particularly of the receipt surface 2, the attachment device 5 has good compactness and reliable and secure operation, in that, during the movement of rotation of the drum 1 around the central axis Z1, it is not liable to collide with an object which would be axially close to the drum 1.

According to a preferred characteristic of the attachment device 5 which can constitute an invention in its own right, adaptable in particular to different types of tire building supports other than drums 1, as can clearly be seen in FIGS. 3 to 8, the actuation mechanism 10 comprises an articulated quadrilateral 20, a first and a second top of which are formed respectively by a first pivot 21 belonging to the base 6, and by a second pivot 22 belonging to the base 6, and a third and fourth top of which are formed respectively by a third pivot 23 and a fourth pivot 24 which both belong to a platform 25 which supports the clamping jaw 7.

In a reference system attached to the base 6, and thus attached to the receipt surface 2, the base 6 forms a fixed base, and the platform 25 forms a platform 25 which is movable, designed to reach alternately firstly a first position (FIG. 4, FIG. 8), corresponding to a position in which the clamping jaw 7, attached on the platform 25, is in the position of rest P0, and secondly a second position (FIG. 3, FIG. 5) in which the clamping jaw 7, attached on the platform 25, is in the position of work P1.

Advantageously, an articulated quadrilateral structure 20 according to the disclosure is particularly simple and robust and makes it possible to provide the clamping jaws 7 with a concave, quasi-parabolic trajectory T7, which provides the advantages described above The respective axes Z21, Z22, Z23, Z24 of the first, second, third and fourth pivots 21, 22, 23, 24 are parallel to one another.

This permits the deformation of the articulated quadrilateral 20 on a plane, in this case a radial plane, containing the central axis Z1 of the drum 1.

More particularly, the axes Z21, Z22, Z23, Z24 of the first, second, third and fourth pivots 21, 22, 23, 24 are all normal to the same radial reference plane, known as the “sagittal plane” PS, which contains the central axis Z1 of the drum 1, and subdivides the drum 1 into two parts which are substantially relative to one another.

By convention, the sagittal plane PS preferably corresponds to the radial plane which contains firstly the central axis Z1, and secondly the radius which is perpendicular to the central axis Z1, and corresponds to the bisectrix which divides into two equal angular subsectors the angular subsector which the tile 12 covers, at the azimuth, around the central axis Z1.

In addition, the first, second, third and fourth pivots 21, 22, 23, 24 are advantageously distinct from one another, and not coaxial in relation to one another, such that the tops of the articulated quadrilateral 20 are distinct and spaced from one another.

It will also be noted that the first pivot 21 is radially closer to the central axis Z1 than the third pivot 23, and that, similarly, the second pivot 22 is radially closer to the central axis Z1 than the fourth pivot 24. The first pivot 21 is in this case also radially closer to the central axis Z1 than the second pivot 22.

As can be seen clearly in the FIGS. 3, 4, 5, 6, 7 and 8, the platform 25 is preferably connected to the base 6 by means of firstly a first arm 26, which connects the first pivot 21 to the third pivot 23, thus defining a first side 26A of the articulated quadrilateral 20, and secondly by a second arm 27, which connects the second pivot 22 to the fourth pivot 24, thus defining a second side 27A of the articulated quadrilateral 20.

It will be noted that, irrespective of the form of the first arm 26, which is used to connect the first pivot 21 materially to the third pivot 23, “first side” 26A will designate the straight segment which, geometrically, joins the first pivot 21 to the third pivot 23, and, more particularly, the straight segment which is perpendicular to, and intersects, the axes Z21 of the first pivot 21, and Z23 of the third pivot 23, and thus, on the aforementioned sagittal plane PS, joins the center of rotation of the first pivot 21 to the center of rotation of the third pivot 23, i.e. which joins the first top of the articulated quadrilateral 20 to the third top of the articulated quadrilateral 20.

Similarly “second side” 27A designates the straight segment which, irrespective of the material form of the second arm 27, geometrically joins the second top of the articulated parallelogram 20, thus the center of rotation of the second pivot 22, to the fourth top of the articulated parallelogram 20 formed by the center of rotation of the fourth pivot 24.

It will be noted that the form of the first arm 26, and respectively the form of the second arm 27, can vary without departing from the context of the invention.

In this case, for simplicity of construction, the first arm 26 and the second arm 27 are preferably straight.

Preferably, the first arm is formed by a connection rod, or a pair of connection rods parallel to one another, which each connect the first pivot 21 to the third pivot 23. Similarly, the second arm 27 is formed by a connection rod, or a pair of connection rods parallel to one another, which each connect the second pivot 22 to the fourth pivot 24.

The receptacle 13 hollowed in the tile 12 in order to receive the base 6 and at least part of the actuation mechanism 10, will preferably be a through opening, such as to open onto the radially outer face of the tile 12, in order to permit the passage of the first and second arms 26, 27, as well as the course of the the arms 26, 27 and the platform 25 during movements of engagement FWD and disengagement BWD. Preferably, the receptacle 13 will thus form an indentation cut into the axially outermost edge of the tile 12.

It will be noted that the attachment device 5 will preferably be designed such that, both in the position of rest P0 and in the position of work P1, the first and second arms 26, 27, as well as the radially outermost surface of the platform 25, on which the clamping jaw 7 is attached, are situated radially recessed from the radially outer face of the tile 12, (i.e., they are closer to the central axis Z1 than the radially outer face of the tile 12), such as to be recessed in relation to the apparent surface of the tile 12 and to the receipt surface 2. In this case also, this arrangement will contribute to the compactness of the attachment device 5.

The first arm 26 provides the first side 26A with a fixed length L26A, i.e. it establishes an invariable distance between the first pivot 21 and the third pivot 23, i.e. the first arm 26 maintains a distance between centers with a constant value between the first pivot 21 and the third pivot 23. Thus, the length L26A of the first side 26A will be constant during the movements of engagement FWD then disengagement BWD.

In this case, it will be possible to provide a fixed regulation system, making it possible to modify, before implementation of the movements of engagement FWD then disengagement BWD, the length L26A of the first side, in order to adjust the required distance between centers between the first pivot 21 and the third pivot 23. For this purpose, the first arm 26 could for example have a telescopic structure with an adjustable length, which can be locked at the length required by any means, such as a screw.

The same will apply to the second arm 27, which will define a length L27A of the second side 27A, i.e. the distance between centers which separates the second pivot 22 from the fourth pivot 24, which will be fixed, and optionally adjustable by a regulation system.

A regulation system of this type will make it possible advantageously inter alia to adapt the position of work P1 according to the thickness E3 of the component element of the tire 3, which it is wished to maintain by clamping on the receipt surface 2.

Particularly preferably, the length of the second side L27A (i.e., as indicated above, the distance which separates the axis Z24 of the fourth pivot 24 from the axis Z22 of the second pivot 22) is smaller than the length of the first side L26A (i.e., as indicated above, the distance which separates the axis of the third pivot 23 from the axis of the first pivot 21). That is, L27A<L26A.

In other words, the second arm 27 is shorter than the first arm 26.

Thanks to this difference in length between the first arm 26 and the second arm 27, the articulated quadrilateral 20 forms a “false parallelogram”, which advantageously makes it possible to combine with the aforementioned globally parabolic trajectory T7, during the movement of disengagement BWD, a component of tilting BWD_P of the clamping jaw 7, in pitch form around the circumferential direction X1.

This tilting in pitch form BWD_P, which takes place from the start of the movement of disengagement BWD, advantageously makes it possible to detach the clamping jaw 7 from the radially outer face 3_out of the component element of the tire 3 supported on the receipt surface 2, without the clamping jaw 7 exerting any friction, and thus axial traction, on the component element of the tire 3.

Thus, there is no danger of displacing the front end portion 3F of the component element of the tire 3 accidentally when the clamping jaw 7 leaves its position of work Pl in order to reach its position of rest P0.

An arrangement of this type, using arms 26, 27 with different lengths, also has the advantage of accentuating the radial nature of the orientation of approach during the final phase of the movement of engagement FWD and thus assists generation of a radial clamping force F_clamp with a strong intensity.

It will be noted that the shorter arm, in this case the second arm 27, and thus the second and fourth pivots 22, 24, are closer axially to the portion of the receipt surface 2 which receives the component element of the tire 3, than the longer arm, in this case the first arm 26, and the first and third pivots 21, 23.

In an equivalent manner, the first and third pivots 21, 23, as well as the first arm 26 (long arm) are thus axially further from the equatorial plane PE of the drum 1 than, on the same side of the equatorial plane PE, the second and fourth pivots 22, 24 and the second arm 27 (short arm).

The actuation mechanism 10 can be motorised by any type of motor, i.e. electric, pneumatic, or hydraulic.

Preferably, the actuation mechanism 10 is driven by a jack 30, for example a double-effect pneumatic jack, the body 31 of which is supported by the base 6, and the rod 32 of which is engaged on the first arm 26, at a fifth pivot 33, by means of which the rod 32 is articulated on the first arm 26. This fifth pivot 33 is situated between the first pivot 21 and the third pivot 23, at a distance from each of the first and third pivots 21, 23.

The axis Z33 of this fifth pivot 33 is also parallel to the axes Z21, Z22, Z23, Z24 of the first, second, third and fourth pivots 21, 22, 23, 24.

Advantageously, a highly compact arrangement of this type allows the jack 30 to give rise to the tilting of the first arm 26, and thus to the deformation of the articulated quadrilateral 20, and consequently to the displacement of the platform 25 and the clamping jaws 7, alternately in a direction corresponding to the movement of engagement FWD, in this case in FIGS. 5 to 8, by making the first arm 26 tilt clockwise, by retracting the rod 32 into the body 31 in the direction of the straight line, then in an opposite direction corresponding to the movement of disengagement BWD, in this case in FIGS. 5 to 8, by making the first arm 6 tilt in the anticlockwise direction, by deploying the rod 32 from the body 31 towards the left.

Preferably in particular in order to assist the compactness of the attachment device 5, the fifth pivot 33 is radially further from the central axis Z1 than the first pivot 21, and radially closer to the central axis Z1 than the second pivot 22.

Preferably, the body 31 of the jack 30 is articulated on the base 6 at a sixth pivot 34, the axis Z34 of which is parallel to the axis Z33 of the fifth pivot 33.

The jack 30 is preferably positioned substantially parallel to the central axis Z1, in the receptacle 13, opposite the radially inner face of the tile 32, such that the direction of displacement in translation of the rod 32 is parallel to the central axis Z1 to within +/−10°. For this purpose, the sixth pivot 34 is preferably situated axially closer to the equatorial plane PE than the fifth pivot 33. An arrangement of this type makes it possible to reconcile compactness and power of the actuation mechanism 10.

According to a preferential characteristic of the attachment device 5, which can constitute an invention in its own right, adaptable to different types of actuation mechanisms 10, which, it will be appreciated, include the articulated quadrilateral 20 actuation mechanism 10 described above, and/or adaptable to different types of tire building supports, whether the the support is a drum 1 or something other, the clamping jaw 7 is formed, as shown clearly in FIGS. 3 and 4, by a leaf spring 40, which is designed such as to be able to bend resiliently under the stress of the clamping force F_clamp.

Thus, the clamping jaw 7 is not only simple, light, compact and robust, but also has flexibility (compliance) which allows it to bend resiliently in contact with the component element of the tire 3, against the resistance opposed by the underlying receipt surface 2, under the clamping force F_clamp.

The clamping action, which is derived from the forced application of the leaf spring 40 against the component element of the tire 3, under the action of the jack 30 transmitted via the actuation mechanism 10 (and in particular via the first arm 26 which forms a lever), thus adapts automatically to the thickness E3 and to the intrinsic rigidity in compression of the component element of the tire 3.

The leaf spring 40 is advantageously fitted flat on the platform 25, such that the thickness E40 of the leaf spring 40 is oriented in a radial direction Y1 (in this case the radial direction Y1 which, together with the central axis Z1, generates the aforementioned sagittal plane PS), in order to permit bending which has the effect of curving the leaf spring 40 around the circumferential direction X1, i.e. bending which is derived from a bending moment supported by the circumferential direction X1.

By way of indication, the leaf spring 40 can be made of steel, in particular a spring steel containing silicon, or also an alloy based on aluminium, or also of a composite material. Preferably, the face of the leaf spring 40, in this case the radially inner face of the leaf spring 40, which is designed to come into contact with the component element of the tire 3, and thus in this case is designed to come into contact with the radially outer face 3_out of the component element of the tire 3, can be coated with an anti-adhesive material, such as Xylan®.

Preferably, the leaf spring 40 can have a thickness of between 0.5 mm and 3 mm, for example between 1 mm and 2 mm.

This relative fineness makes it possible not only to provide the leaf spring 40 with good flexibility and suitable resilience in flexure, but also to minimise the radial size of the leaf spring 40, in order, when the clamping jaws 7, and thus in this case the leaf spring 40, occupy the position of work P1, in order to limit the interference between the the leaf spring 40 and the guiding and laying units responsible for conveying the component element of the tire 3 to the drum 1, and for positioning and guiding the component element of the tire 3 in relation to the drum 1 during the winding operation.

In particular, the narrow thickness of the leaf spring 40 limits the radial height of any projection formed by the leaf spring 40 on the receipt surface 2 in the position of work 1P1, and thus allows an applicator roller, which is designed to apply the component element of the tire 3 on the drum 1, to roll on the receipt surface 2 in the circumferential direction X1, and to clear the location occupied by the leaf spring 40, and therefore to clear the projection, by passing partly onto the leaf spring 40, without any damage either to the applicator roller, or to the component element of the tire 3, or to the leaf spring 40.

According to a possible arrangement, in this respect, it will also be possible to chamfer or round the lateral ridges of the radially outer face of the leaf spring 40, which ridges are in this case parallel to the central axis Z1, in order to form ramps which will facilitate clearing of the ridges by the applicator roller, in the circumferential direction X1.

Preferably, as can be seen clearly in FIGS. 3, 5, 6, 7 and 8, the leaf spring 40 is fitted cantilevered, such as to have firstly a captive portion 40A, which is attached supported on the platform 25, and secondly a free end portion 40B, which projects axially in relation to the platform 25, such as to be able to come into contact with the component element of the tire 3 when the clamping jaw 7 is brought to the position of work Pl.

In this case also, an arrangement of this type contributes towards the lightness, simplicity and robustness of the attachment device 5, while assuring good flexibility of the clamping jaw 7.

Preferably, as shown in particular in FIG. 3, the leaf spring 40 comprises at least one slot 41, which extends axially over a portion of the length of the leaf spring 40, such as to subdivide the leaf spring 40 into at least two tongues 42, 43, which are each designed to come into contact with the component element of the tire 3, when the clamping jaw 7 is in the position of work P1, and which each occupy a different angular sector around the central axis Z1.

Advantageously, the subdivision into tongues 42, 43 makes it possible to reduce the rigidity, and thus increase the flexibility, of the leaf spring 40, while maintaining a thickness E40 which is sufficiently great to allow the leaf spring to withstand the plastification under the clamping force F_clamp, i.e. to allow the leaf spring 40 not to undergo irreversible plastic deformation when the leaf spring 40 is pressed against the component element of the tire 3.

The presence of the at least one slot 41 consequently improves the flexibility of the attachment device 5 in relation to a leaf spring 40 which would be solid over its entire length, considered in the circumferential direction X1, i.e. which would be solid over the entire portion of circumference of the receipt surface 2 which the leaf spring 40 covers, around the central axis Z1, when the leaf spring 40 is in the position of work P1.

In addition, the subdivision into at least two tongues 42, 43 makes it possible to dedicate each of the tongues 42, 43 to a specific angular sector around the central axis Z1, with each tongue 42, 43 thus generating its own support on the component element of the tire 3, independently from the other tongue 43, 42, which allows the clamping jaw 7, in this case the leaf spring 40, to match better the curvature of the drum 1, considered on a plane normal to the central axis Z1, by means of a double support.

Preferably, as shown in FIGS. 3 and 4, the slot 41 extends axially as far as the axial end of the free end portion 40B of the leaf spring 40. The at least two tongues 42, 43, thus form terminal tongues 42, 43, the respective axial ends of which are free, and in particular free to bend independently from one another.

According to an arrangement of this type, the at least two tongues 42, 43 form the free end portion 40B, whereas they are attached to, and in this case formed integrally with, a single common root, which for its part forms the captive portion 40A attached to the platform 25.

It will be appreciated that the present disclosure also relates as such to a tire building installation 50. The tire building installation 50 includes a frame 51and a drum 1 according to any one of the possible variants of the present disclosure. The drum 1 is fitted such as to rotate relative to the frame 51 so as to be able to rotate about itself around its central axis Z1. The tire building installation 50 also includes at least one supply system 52, which is designed to convey to the drum 1 a component element of the tire 3 which is in the form of a strip 4 such that it is possible to attach the front end portion 3F of the strip 4 supplied by the supply system 52 on the receipt surface 2 of the drum 1 by means of the attachment device 5, then wind the strip 4 around at least one complete turn, and preferably around a plurality of complete turns, around the central axis Z1, on the receipt surface 2, by rotating the drum 1 around its central axis Z1.

In a known manner, the rotation of the drum in relation to the frame 51, which makes it possible to wind each strip 4 and thus close it in a loop on itself around the central axis Z1, can be carried out by an electric motor.

The supply system 52 can be formed for example by a paying-out device which receives a bobbin where the strip 4 is stored, which strip is then unwound from the bobbin as the strip is wound on the drum 1, or also by a calender which produces continuously the required quantity of the strip 4, by passing simultaneously between two rollers, defining an air gap corresponding to the thickness E3 of the strip 4, reinforcement wires, as well as two fine layers of rubber which sandwich the reinforcement wires.

As previously indicated, the supply system 52 can comprise guiding and laying units (not represented), in particular an applicator roller, which make it possible to guide the strip 4 and apply the strip 4 on the receipt surface 2 of the drum 1.

In addition the attachment device 5, and more globally the drum 1 and thus the tire building installation 50, preferably comprise an interchangeable set of clamping jaws 7, in the form of a set of a plurality of leaf springs 40 with different lengths, in order to be able to adapt the clamping device 5 according to the axial position and/or the axial width W3 of the component element of the tire 3 which it is wished to maintain on the drum 1.

Thanks to this plurality of removable and interchangeable leaf springs 40, the attachment device 5, and more globally the drum 1 thus equipped, therefore has great polyvalence, since it can adapt to numerous models and dimensions of tires.

Preferably, a plurality of the leaf springs 40, or even all of the leaf springs 40, are slotted in order to have tongues 42, 43 as described above.

The present disclosure also concerns a tire building process, during which a front end portion 3F of a component element 3 of the tire 3, in this case a strip 4, is maintained on a drum 1 according to the present disclosure, by means of the attachment device 5 supported by the drum 1, while the component element 3 of the tire, in this case the strip 4, is being wound on the drum 1.

Preferably, during this process for production of a tire, the component elements of the tire 3, in this case the strip 4, is one wound from the front end portion 3F of the component element of the tire which forms the starting point of a first turn, in a plurality of consecutive helical turns, including at least one second turn which follows the first turn.

The helical turns are offset axially relative to one another, such that the turns do not overlap axially the front end portion 3F of the component element of the tire 3, or at the most overlap the front end portion 3F only partly, axially.

According to this same process, the size of the clamping jaws 7, in this case the axial length of the leaf spring 40, is selected such that, when the clamping jaw 7 is in the position of work Pl in order to maintain the front end portion 3F on the receipt surface 2 of the drum 1, the clamping jaw 7 is interrupted axially before the axial area which is occupied by the second turn and the following turns, such that no turn covers and traps the clamping jaw 7.

Advantageously, since the clamping jaw 7, in this case the leaf spring 40, is in no way wedged by the turns of the component element of the tire 3, because the clamping jaw 7 is placed on the first turn, but is interrupted axially before the edge of the second turn, it is then possible to withdraw the clamping jaw 7, in order to make it leave its position of work Pl, and to make it return to its position of rest P0, without disrupting or damaging the annular unit formed by the assembly of the turns.

The operation of the attachment device according to the present disclosure will now be described briefly with reference to FIGS. 5, 6, 7 and 8.

Initially (FIG. 8), the clamping jaw 7, which, for the sake of convenience, will be assimilated to a leaf spring 40 hereinafter, is in the position of rest P0, outside the area of the receipt surface 2, where the component element of the tire 3 will be positioned. For convenience of description, the component element of the tire 3 will be assimilated to a strip 4 hereinafter. The drum 1 is immobile.

The leaf spring 40 supported by the platform 25 is selected, and if necessary replaced, such as to adapt the attachment system 5 to the tire which it is wished to build. If applicable, by means of the regulation system, the fixed regulations of the actuation mechanism 10, in this case in particular the respective fixed lengths L26A, L27A of the first and second arms 26, 27 of the articulated quadrilateral 20, are also adjusted.

Once the attachment system 5 is ready, the supply system 52 supplies at least part of the strip 4, the front end portion 3F of which is applied to the receipt surface 2, in the required starting position. This starting position is such that it overlaps the position of work P1 at least partly, so that this position of work is defined by the scope of the course of the actuation mechanism 10 of the attachment system 5, and by the dimensions of the leaf spring 40 selected.

The activation of the jack 30 is then commanded by an appropriate control unit, such that the jack 30 actuates its rod 32, in this case retracts the rod 32 into the body 30, and therefore gives rise to the tilting, in this case in the clockwise direction in FIGS. 7, 6 and 5, of the first arm 26.

This forced tilting of the first arm 26 induces deformation of the articulated quadrilateral 20 around its pivots 21, 22, 23, 24, and is thus converted into a concave curved, quasi-parabolic movement of the platform 25 and thus of the leaf spring 40 supported by the the platform 25, in relation to the central axis Z1.

During the first phase (passage from FIG. 8 to FIG. 7) of the movement of engagement FWD, corresponding to the ascending phase of the quasi-parabolic trajectory T7, the leaf spring 40 is raised radially according to the first centrifugal radial component FWD_R1, and starts to progress according to an axial component FWD_A, directed towards the equatorial plane PE of the drum, until it reaches the apogee of its trajectory T7, corresponding to the position represented in FIG. 7.

Preferably, the actuation mechanism 10 is designed such that, at this apogee, the first arm 26 and the second arm 27 are both simultaneously extended radially (i.e., the third pivot 23 is radially plumb with the first pivot 21) and the fourth pivot 24 is radially plumb with the second pivot 22. This selection of configuration at the apogee of the trajectory T7, which corresponds substantially to a position situated halfway between the position of rest P0 and the position of work P1, makes it possible in particular to maintain relative parallelism between the leaf spring 40 and the receipt surface 2 in each of the two useful end positions of the trajectory T7, i.e. the position of rest P0 and the position of work Pl.

The movement of engagement FWD is continued by a descending phase of the quasi-parabolic trajectory T7, combining an axial component FWD_A directed towards the equatorial plane PE, and a second radial component FWD_R2, in this case centripetal, which allows the leaf spring 40 to descend towards the central axis Z1, and thus towards the receipt surface 2, and therefore to approach progressively the strip 4 (FIG. 6), and more specifically the radially outer face 3_out of the strip 4, until the position of work P1 is reached, in which the leaf spring 40 is supported against the strip 4 (FIG. 5).

The traction exerted on the rod 32 of the jack 30 thus takes the form of a substantially radial clamping force F_clamp, which places the strip 4 against the receipt surface 2, in the required location for forming the starting point of the winding.

It will be noted that, advantageously, the difference of length between the first arm 26 and the second arm 27 creates, during the descending phase of the movement of engagement FWD, a tilting in pitch form FWD_P of the leaf spring 40, in this case in the clockwise direction around the circumferential direction X1 in FIGS. 6 and 5, which tilting in pitch form lowers the slotted free end portion 40B of the leaf spring 40, and thus assists the application of the leaf spring 40 on the radially outer face 3_out of the strip 4 in a direction which is quasi-radial, and thus quasi-normal to the receipt surface 2, without generating undesirable axial movement of the the strip 4 on the receipt surface 2.

In addition the flexibility of the leaf spring 40 allows the leaf spring 40 to be deformed resiliently in contact with the strip 4 supported by the receipt surface 2, and thus to adapt with flexibility to the clamping force F_clamp and the distribution of the clamping, according to the geometry and dimensions of the drum 1 and of the strip 4.

Once the strip 4 has been locked on the receipt surface 2 by the attachment device 5 (FIG. 5, FIG. 1A), the rotation of the drum 1 is started around the central axis Z1.

The attachment device 5 is driven integrally with the drum 1 in this movement of rotation, and, since the attachment device 5 maintains the strip 4 firmly in the selected position on the circumference of the drum 1, the strip 4 is driven, by longitudinal traction, in the circumferential direction X1, and thus begins to wind onto the drum 1.

The rotation of the drum continues for as long as necessary in order to create the required number of turns of the strip 4 on the drum 1.

Preferably, this rotation of the drum 1 is accompanied by relative axial displacement of the supply system 52, and more particularly of the applicator roller, in relation to the drum 1, parallel to the central axis Z1, in order to generate helical winding around a plurality of turns, with the required pitch.

Once the winding of the strip 4 has been completed, the rotation of the drum 1 is stopped, then the attachment device 5 is actuated once more, this time in order to release the strip 4 by implementing the movement of disengagement BWD.

Optionally, before implementing the movement of disengagement BWD, it will be possible to maintain the clamping jaw 7 temporarily in the position of the work P1 for the time necessary for reconfiguration of the drum 1, and more globally, the time necessary for reconfiguration of the installation 50, for the purpose of carrying out a second operation of winding intended to place on the drum 1 another component element of the tire 3, on top of the strip 4 placed during the first winding operation.

For example, thus, it will be possible to maintain the clamping jaw 7 in the position of work Pl for the time necessary to transfer the drum 1 bearing the strip 4 from the building station where the operation of winding of the strip 4 took place, to another, distant building station, designed to carry out another winding operation intended to place another component element of the tire 3 on the drum 1, on top of the strip 4. According to another example, it will be possible to maintain the clamping jaw 7 in the position of work Pl for the time necessary to reorient the drum 1 at the azimuth around the central axis Z1, within the building station which has already been used to wind the strip 4, in order to define the starting position from which it is wished to wind the new component element of the tire 3 on top of the strip 4 already in place. It will also be possible to maintain the clamping jaw in the position of work P1 until the start of the laying, on top of the strip 4, of the new component element of the tire 3.

In order to implement the movement of disengagement BWD, the rod 32 of the jack 30 is deployed in order to make the first arm 26 tilt in the direction which is the inverse of the direction previously used for the movement of engagement FWD, therefore in this case in the anticlockwise direction in FIGS. 6 to 8.

The return trajectory T7 corresponding to the movement of disengagement BWD is identical to that of the movement of engagement FWD, but is travelled in the inverse direction.

Thus, there is once again a quasi-parabolic concave curved trajectory T7 comprising a first ascending phase (FIGS. 6 and 7), during which there is combination of tilting in pitch form BWD_P, a first centrifugal radial component BWD_R1, and a reverse axial component BWD_A in the direction going away from the equatorial plane PE, which makes it possible to detach the leaf spring 40 and move it away from the strip 4. Advantageously, the leaf spring 40 is detached and removed from the strip 4 without exerting friction, or axial or circumferential traction, on the strip 4.

Once the apogee has been passed (FIG. 7), this withdrawal trajectory T7 then comprises a descending phase (FIGS. 7 and 8), which combines an axial component BWD_A of withdrawal and a second radial component BWD_R2, which in this case is centripetal radial, and makes it possible to return the leaf spring to the position lowered against the tile 12, in the position of rest P0 (FIG. 8). The installation 50 thus provides a clear field for access to the receipt surface 2 which bears the wound strip 4, either in order to proceed to lay another component element of the tire 3 on top of the wound strip 4, or to remove from the drum 1 the annular unit thus formed by the wound strip 4.

It will be appreciated that the present disclosure is not in any way limited simply to the variant embodiments disclosed in the foregoing, and in particular persons skilled in the art are capable of isolating or combining freely with one another one or the other of the aforementioned characteristics, or substituting them by equivalents.

In particular, it can be envisaged to adapt to any type of application an attachment device 5 comprising an articulated quadrilateral 20, supported by a base 6, as well as a leaf spring 40, in particular a slotted leaf spring 40, irrespective of the building support for which it is destined, and on which the attachment device 5 is attached.

What is claimed is:

1. A drum for building of a tire, said drum having a central axis and having a radially outer receipt surface, said radially outer receipt surface extending along and around said central axis, and the radially outer receipt surface being designed to receive at least one component element of said tire, said drum further comprising an attachment device which is designed to maintain said component element of the tire on said receipt surface, said attachment device comprising:
a base which is attached on the drum such that the attachment device is supported by said drum;
a clamping jaw which is designed to adopt a position of work in which said clamping jaw is supported on a radially outer face of the component element of the tire, whereas an opposite face, forming a radially inner face, of said component element of the, is supported on the receipt surface in order to exert on said component element of the tire a radial compression clamping force which maintains said component element of the tire on said receipt surface;
an actuation mechanism which is supported by the base and connects the clamping jaw to said base, said actuation mechanism being designed to make the clamping jaw execute, in relation to the base and thus in relation to the receipt surface, alternately an engagement movement which makes it possible to bring the clamping jaw from a position of rest to the position of work and a disengagement movement which makes it possible to return the clamping jaw to the position of rest by displacing the clamping jaw so as to be withdrawn from the position of work, both according to a radial component in order to release the clamping force and according to an axial component, in order to clear the axial area which is occupied, on the receipt surface, by the component element of the tire.

2. A drum according to claim 1, wherein the actuation mechanism comprises an articulated quadrilateral, a first and a second top of which are formed respectively by a first pivot belonging to the base, and by a second pivot belonging to the base, and a third and fourth top of which are formed respectively by a third pivot and a fourth pivot which both belong to a platform which supports the clamping jaw, wherein the respective axes of the first, second, third and fourth pivots are parallel to one another, wherein the platform is connected to the base by means of firstly a first arm, which connects the first pivot to the third pivot, thus defining a first side of the articulated quadrilateral, and secondly a second arm, which connects the second pivot to the fourth pivot, thus defining a second side of the articulated quadrilateral, and wherein the distance which separates the axis of the fourth pivot from the axis of the second pivot is smaller than the the distance which separates the axis of the third pivot from the axis of the first pivot.

3. The drum according to claim 2, wherein the actuation mechanism is driven by a jack, the body of which is supported by the base, and the rod of which is engaged on the first arm at a fifth pivot by means of which said rod is articulated on said first arm and is situated between the first pivot and the third pivot at a distance from each of said first and third pivots

4. The drum according to claim 1, wherein the clamping jaw is formed by a leaf spring that is designed so as to be able to bend resiliently under the stress of the clamping force.

5. The drum according to claim 2, wherein the clamping jaw is formed by a leaf spring that is designed so as to be able to bend resiliently under the stress of the clamping force, and wherein the leaf spring is fitted cantilevered, so as to have firstly a captive portion which is attached supported on the platform, and secondly a free end portion which projects axially in relation to the platform, so as to be able to come into contact with the component element of the tire when the clamping jaw is brought to the position of work.

6. The drum according to claim 4, wherein the leaf spring comprises at least one slot which extends axially over a portion of the length of said leaf spring so as to subdivide said leaf spring into at least two tongues which are each designed to come into contact with the component element of the tire when the clamping jaw is in the position of work and which each occupy a different angular sector around the central axis.

7. The drum according to claim 1, wherein the drum is subdivided into a plurality of tiles which are distributed at the azimuth around the central axis so as to form together the receipt surface, and wherein the attachment device is incorporated in one of said tiles.

8. A tire building installation, comprising:
a frame;
a drum according to claim 1, said drum being fitted so as to rotate relative to the frame, so as to be able to rotate about itself around its central axis;
at least one supply system which is designed to convey to the drum a component element of the tire which is in the form of a strip, such that it is possible to attach the front end portion of the strip supplied by the supply system on the receipt surface of the drum, by means of the attachment device, then wind said strip around at least one complete turn around the central axis, on the receipt surface, by rotating the drum around its central axis.

9. The installation according to claim 8, further comprising an interchangeable set of clamping jaws in the form of a set of a plurality of leaf springs with different lengths in order to be able to adapt the clamping device according to at least one of the axial position and the axial width of the component element of the tire which it is wished to maintain on the drum.

10. A process for production of a tire, during which a front end portion of a component element of the tire is maintained on a drum according to claim 1 by means of the attachment device supported by said drum while said component element of the tire is being wound on said drum.

11. The process according to claim 10, during which the component element of the tire is wound from the front end portion of the component element of the tire which forms the starting point of a first turn, in a plurality of consecutive helical turns, including at least one second turn which follows the first turn, which consecutive helical turns are offset axially relative to one another, such that said turns do not overlap axially the front end portion of the component element of the tire, or at the most overlap the said front end portion only partly, axially, and during which the size of the clamping jaw is selected such that, when said clamping jaw is in the position of the work in order to maintain the front end portion on the receipt surface of the drum, the clamping jaw is interrupted axially before the axial area which is occupied by the second turn and the following turns, such that no turn covers and traps the said clamping jaw.

12. The tire building installation according to claim 8, wherein the attachment device winds the strip on the receipt surface of the drum over a plurality of complete turns.
